(19) United States
(12) Patent Application Publication
(10) Pub. No.: US 2005/0231335 A1
(43) Pub. Date: Oct. 20, 2005

(54) Vehicle alarm remote paging system

(76) Inventors: Richard L. Miller JR., Palmyra, IN (US); Teresa F. Miller, Palmyra, IN (US); Jay Darren Miller, Greenwood, IN (US); James Whitehead, Clarkesville, IN (US); Larry Grube, New Albany, IN (US); Frank Sedlasek, Elk Grove Village, IL (US); Peter Muth, Stream Wood, IL (US)

Correspondence Address: SIERRA PATENT GROUP, LTD., P O BOX 6149, STATELINE, NV, 89449, US

(21) Appl. No.: 10/936,456

(22) Filed: Sep. 7, 2004

Related U.S. Application Data
(63) Continuation of application No. 09/533,236, filed on Mar. 22, 2000, now abandoned.
(60) Provisional application No. 60/126,331, filed on Mar. 26, 1999.

(51) Int. Cl. B60R 25/10

(52) U.S. Cl. 340/426.18; 340/539.18; 340/531

(57) ABSTRACT

A vehicle theft system adapted for cooperation with a security service provider over a network comprising a security service provider coupled to a network, a police network coupled to the security service provider through the network, a customer unit in communication with the security service provider, and the security service provider being configured to notify the police network in the event of a theft of the customer unit.

### CROSS-REFERENCE TO RELATED APPLICATION

This application is a continuation of co-pending U.S. patent application Ser. No. 09/533,236, filed Mar. 22, 2000, which claims the benefit of U.S. Provisional Application Ser. No. 60/126,331, filed Mar. 26, 1999.

### BACKGROUND OF THE INVENTION

1. Field of the Invention

This invention relates generally to remote control of a vehicle alarm system through a commercial two-way radio-frequency (RF) digital data carrier.

2. Background of Related Art

The typical vehicle, e.g., an automobile, has increased in cost consistently over the past several years. Consumer forecasters see this trend continuing into the near future.

As the costs of vehicles have increased, the desirability of vehicles to car thieves has also correspondingly increased. In response to increased car thefts, prior art vehicle security systems have relied on various techniques to deter car thieves. For example, a common technique of theft deterrence is to use a steering wheel lock. The steering wheel lock is a device that prevents the steering wheel from being turned in either direction. However, car thieves have easily defeated the steering wheel locks by cutting through the steering wheels.

Other, more sophisticated, techniques involve using car alarm systems or position locating systems within the vehicles. The typical car alarm system operates with a remote electronic key, which activates and deactivates the car alarm system. Once armed, the car alarm system may trigger a loud siren or a flashing of lights of the vehicle based on vibration or noise associated with an unauthorized user breaking into the vehicle. The car alarm system relies on a dutiful bystander to inform law enforcement authorities of an ongoing theft or the vehicle owner investigating the alarm.

However, the typical reaction of bystanders to car alarm sirens is to ignore the car alarms since car alarms often trigger because of the sensitivities of sensors in the car alarm system. Furthermore, experienced thieves may be able to defeat the car alarm systems prior to or just after breaking into the vehicle.

Position locating systems involve placing a device on the vehicle that either broadcasts a homing signal or position data of the vehicle. When a vehicle is stolen, the position locating system is activated. The position locating system broadcasts a homing signal or position data of the vehicle in conjunction with satellites to law enforcement authorities. The position locating systems are effective, but the authorities have to be equipped with the proper equipment to be able to detect the homing signal or to receive the position data. In an era of reduced government budgets, law enforcement authorities may not be able to afford to purchase the appropriate equipment for vehicle recovery, let alone the equipment for multiple competing security systems.

Another factor that may contribute to the higher costs of position locating system is development costs. Manufacturers of position locating systems typically developed their respective systems using proprietary equipment. The manufacturers will typically develop their systems from scratch which incur the costs of research and testing which contribute to the overall cost of the position locating systems.

### SUMMARY OF THE INVENTION

There is a need for an anti-theft vehicle system that provides for two-way communication between the vehicle and a security provider using Standard communication equipment. The purposes of the invention are:

One aspect of the invention is to provide an anti-theft vehicle system that provides the owner of a vehicle the capability to disable a vehicle to prevent theft.

Another aspect of the present invention is to provide an anti-theft vehicle system that provides a wide geographic area of coverage using an existing communication infrastructure.

Yet another aspect of the present invention is to provide an anti-theft vehicle system that provides law enforcement authorities the capability to disable a vehicle without endangering the public.

Yet another aspect of the present invention is to provide an anti-theft vehicle system that provides theft deterrence at a relatively low cost.

Yet another aspect of the present invention is to provide an anti-theft vehicle system that provides location information to one or both the owner of the vehicle or law enforcement authorities over an existing communication infrastructure.

These and other needs are attained by the present invention, where a vehicle theft deterrent system adapted for cooperation with a security service provider, comprising a vehicle theft deterrent device. The vehicle theft deterrent device includes a vehicle interface module, a two-way communication module, and a controller which is configured to generate a signal in the two-way communication module to the security service provider in response to the vehicle interface module detecting a condition in the vehicle such as a dome light current and an ignition activation. The use of a two-way communication module provides the capability of users to communicate with the vehicle using existing communication infrastructure. The system thereby provides a greater coverage area for the theft deterrent system.

Another aspect of the present invention provides for a method of deterring vehicular theft comprising detecting either a dome light current or an ignition activation in a vehicle through a vehicle interface module of a vehicular theft deterrent device. A two-way communication module sends a signal from the vehicular theft deterrent device to a security service provider in response to the detecting, and contacting an owner of the vehicle from the security service provider of the detection. Accordingly, the use of a single security service provider provides access to law enforcement authorities without incurring any extra equipment expenses.

### BRIEF DESCRIPTION OF THE DRAWINGS

Features and advantages of the present invention will become apparent to those skilled in the art from the following description with reference to the drawings, in which:

FIG. 1 shows a block diagram of a theft deterrent system including a commercial two-way communication network, and a security service provider.

FIG. 2 shows another embodiment of the theft deterrent system.

FIG. 3 shows a more detailed block diagram of the theft deterrent unit shown in FIG. 1.

FIG. 4 shows a block diagram of the vehicle theft deterrent unit 115 interfaced with the various systems of the vehicle 110 shown in FIG. 1.

FIG. 5 shows a flow diagram of the functions implemented by the Controller 340 of the vehicle theft deterrent unit.

FIG. 6 illustrates a flow diagram of the local alarm module implemented by the controller shown in FIG. 3.

FIG. 7 illustrates a flow diagram of the remote door module implemented by the controller shown in FIG. 3.

FIG. 8 shows a preliminary bit mode table for the controller shown in FIG. 4.

### DETAILED DESCRIPTION OF ILLUSTRATIVE EMBODIMENTS

The present invention relates to the use of a commercial two-way communication module for preventing automobile theft. In particular, the Commercial two-way communication module, e.g., digital pager module or cellular telephone module, is used in a theft deterrent system. The vehicle theft deterrent unit or device also includes a location positioning system module, an accelerometer module, a vehicle interface, and a controller. The vehicle theft deterrent unit may be operated via two methods: a keyless remote control or by contacting a security service provider via telephone, facsimile, or means of telecommunication equipment.

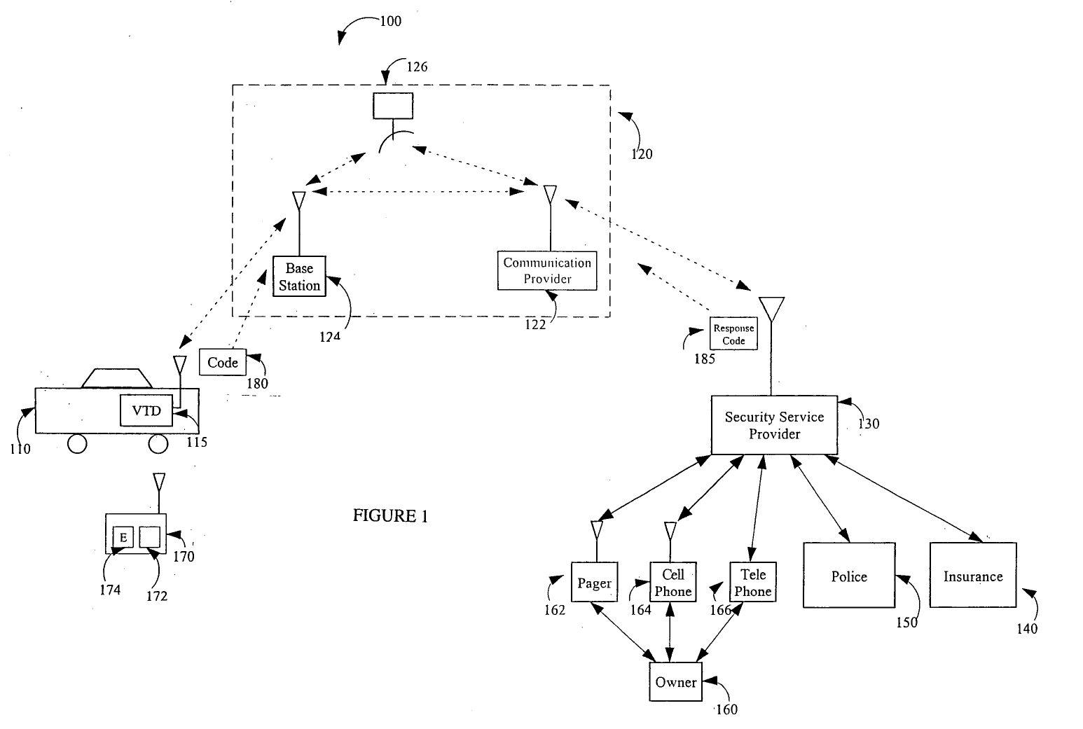

FIG. 1 illustrates an embodiment of the theft deterrent system 100 including a two-way commercial communication system.

As shown in FIG. 1, the theft deterrent system 100 includes a vehicle 110 with an installed vehicle theft deterrent unit 115, a commercial wireless two-way communication system 120, and a security service provider 130. The vehicle 110 is not limited to automobiles and trucks, but the principles of the present invention apply to all types of vehicles such as boats, motorcycles, planes, and trailers.

The commercial wireless two-way communication system 120 includes a wireless communication provider 122, a plurality of base stations 124, and a plurality of satellites 126. The commercial wireless two-way communication system may be a digital pager network, a digital cellular telephone network, or any type of nationwide wireless two-way communication system.

The plurality of base stations 124 are installed over a wide geographic area in such a manner that communications with a commercial two-way communication unit may be enabled in the wide geographic area. The plurality of base stations 124 are in communication with the communication provider 122 directly or in combination with the plurality of satellites 126.

The wireless communication provider 122 provides an interface with the wireless communication system with existing landline communication system such as the plain old telephone system (POTS) or the Internet. Through this interface, users of the commercial wireless two-way communication system may establish communication with other landline users or devices.

The security service provider 130 provides a security service to the users of the vehicle theft deterrent system 100. After a vehicle theft deterrent Unit 115 is installed in a vehicle 110, the owner of the vehicle 160 provides license plate information, vehicle identification number and a serial number of the vehicle theft deterrent unit to the security service provider 130 over POTS or the Internet. The security service provider 130 maintains a secured database of the vehicle theft deterrent unit 115 and an associated security code. If the vehicle 110 is stolen, the owner of the vehicle 160 contacts law enforcement authorities and provides a license plate number of the vehicle 110. Law enforcement authorities 150 contact the security service provider 130 to access the secured database to obtain a contact number for the vehicle theft deterrent unit and the associated security code by cross-referencing the provided license plate number.

The law enforcement authorities 150 may then dial the contact number and associated security code. Upon receiving the associated security code, the vehicle theft deterrent unit 115 will begin deactivation of the vehicle 110.

Another aspect of the present invention is that the vehicle theft deterrent unit 115 will notify one or both of the owner of the vehicle 115 and law enforcement authorities in the event of a vehicle theft or vehicle break-in.

After activation of an installed vehicle theft deterrent unit 115, the vehicle theft deterrent unit 115 is set in an alarm mode. If the vehicle theft deterrent unit 115 detects either one of a dome light current or ignition activation, the vehicle theft deterrent unit 115 transmits a code 180 to the security service provider 130 over the commercial wireless two-way communication system 120. The vehicle theft deterrent unit 115 also simultaneously disables the vehicle, preventing the vehicle from moving. In the event that an authorized user has started the vehicle 110 moving, the vehicle theft deterrent unit 115 may still disable the vehicle 110 according to the following.

The received code 180 is interpreted by the security service provider 130 as a vehicle theft or break-in. Subsequently, the security service provider 130 informs law enforcement authorities, e.g., the police 150, as well as the owner of the vehicle 160. The security service provider 130 may inform the owner 160 using a variety of contact methods such as pager 162, a cellular telephone 164, telephone 166, or whatever type of communication method the owner 160 specifies. The security service provider may also inform the vehicle owner's insurer to begin processing of a claim for the vehicle 110.

The security service provider 130 may send a response code 185 over the commercial two-way communication system 120 to the received code that informs the vehicle theft unit 115 to begin initiation of a deactivation sequence of the vehicle 110 which disables the vehicle 110 when the speed of the vehicle decreases past a pre-determined speed, e.g., five miles per hour with an error margin of two mph.

Yet another aspect of the present invention is the capability of the Vehicle theft deterrent unit 115 to be activated by either a keyless remote control 170 or the security service provider 130.

The keyless remote control 170 is a radio frequency device that allows the owner to control the functionality of the vehicle theft deterrent unit 115. The keyless remote control includes a keypad 172 to Control the functions of the vehicle theft deterrent unit 115. The keyless remote control may also contain an emergency button 174. When the emergency button 174 is activated, vehicle theft deterrent device 115 sends an emergency code which 10 represents an emergency event. The emergency event may be a medical emergency, an accident or a car-jacking. Upon receiving the emergency code, the security service provider 130 will locate the vehicle and send either law enforcement authorities and/or emergency medical personnel.

The vehicle theft deterrent unit 115 may also be controlled remotely by contacting the security service provider 130 via a telephone, pager, or other type of telecommunication device. Once the owner of the vehicle has been identified, the security service provider 130 may activate or deactivate the functions of the vehicle theft deterrent unit 115. Thus, providing an extra measure of security in the event that the keyless remote control 170 is ever lost.

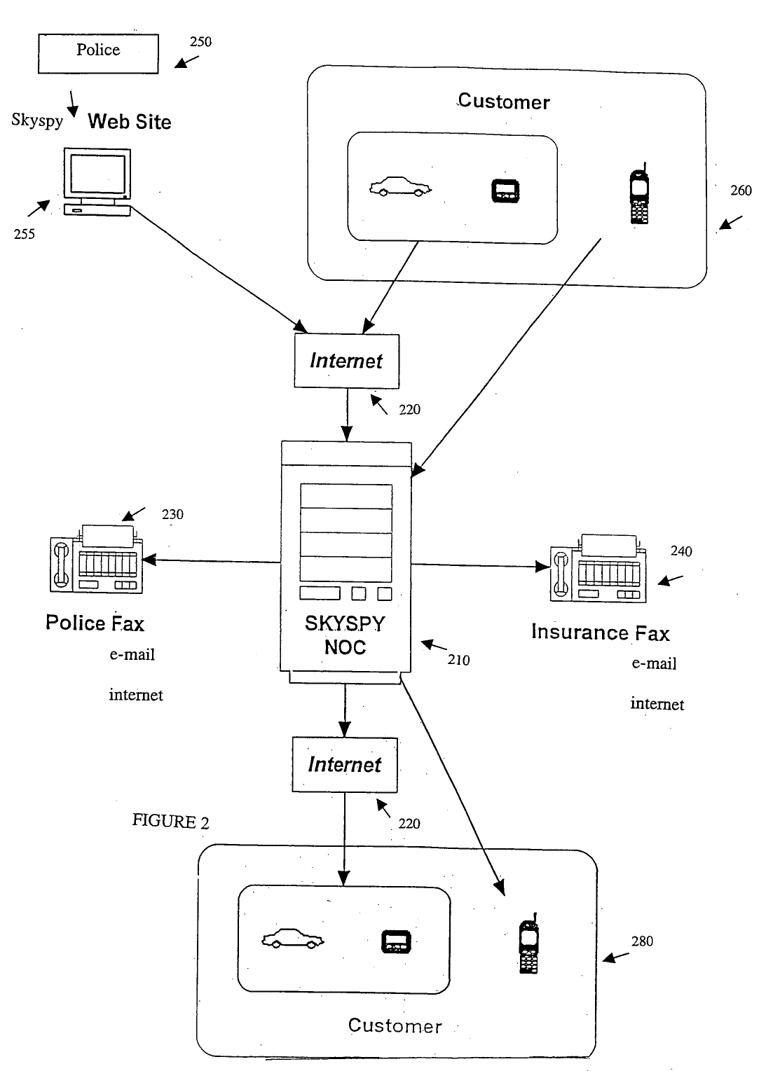

FIG. 2 shows another embodiment of the vehicle theft system 200. As shown in FIG. 2, the vehicle theft system 200 includes a security service provider 210 interfaced to the Internet 220, a police interface 230, and an insurance interface 240. Once informed by the vehicle theft deterrent unit 115 that a theft or break-in has occurred by an authorized user, the security service provider 210 may automatically inform the police via the police through the police interface 230. The police interface 230 may include the Internet, a facsimile, and electronic mail. The security service provider 210 may also automatically inform the insurer of the owner 160 through the insurance interface 240. The insurance interface may include the Internet, facsimile, or electronic mail. The security service provider 210 may provide a license plate number, vehicle identification number, and etc. to the police and the insurance company of the owner.

The Internet interface 220 provides a multi-functional interface to the security service provider 210. Law enforcement authorities, e.g. the police 250 may access the secured database of the security service provider 210 via a secured security service provider website 255. In this manner, the police 250 may quickly obtain the associated security code of a stolen vehicle 110 equipped with the vehicle theft deterrent unit 115 to begin deactivation and recovery of the stolen vehicle 110.

The Internet interface 220 also provides a way for the customer and security service provider 210 to communicate in the event of a stolen vehicle, or the customer 260 and the security service provider 210 may directly communicate over telephone 262.

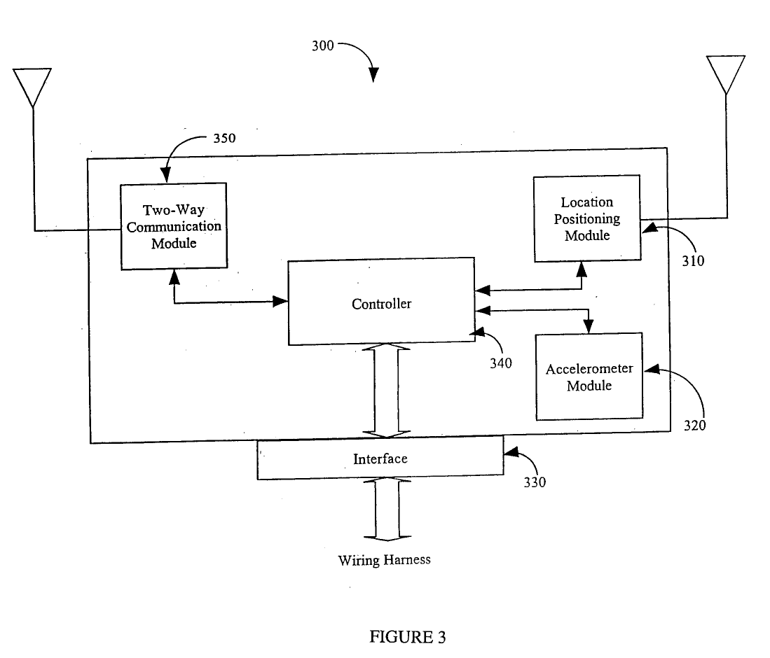

FIG. 3 illustrates a block diagram of a vehicle theft deterrent unit 300 in the vehicle theft deterrent system illustrated in FIG. 1. The theft deterrent unit 300 also includes a location positioning system module 310, an accelerometer module 320, a vehicle interface 330, a controller 340, and a commercial two-way communication module 350. The aforementioned modules may be constructed with commercially available equipment.

The vehicle theft deterrent unit 300 is interfaced with a vehicle's electrical system through the vehicle interface 330. The vehicle interface 330 provides a communication path to vehicle systems such as door lock control, ignition systems, horn system, headlight and parking lights system, and etc. The vehicle interface 330 may be expanded to include factory or after-market alarm systems.

The vehicle interface 330 is in communication with the controller 340. The controller 340 implements the functionality of the vehicle theft deterrent unit 300 that include, but not limited to, local and remote alarm capability, remote door lock control, ignition disable and enable, horn activation, parking lights activation, factory alarm detection, speed detection, radio frequency transmit and receive account status, alarm mode status, ignition status, and etc. The controller may be implemented by using a microprocessor, digital signal processor, or microcontroller.

The controller 340 is also interfaced with an accelerometer module 320. The accelerometer module 320 provides velocity or speed information to the controller. An example of an accelerometer module that may be used in the vehicle theft deterrent unit 115 may be the Analog Device ADXL202JQC.

The location positioning module 310 provides location and position data such as latitude and longitude information to the controller 340. An example of a location positioning module 310 that may be used in the vehicle theft deterrent unit 115 may be PLCC-84-42.

The controller 340 is interfaced with a commercial two-way communication module 350. The commercial two-way communication module 350 may be a digital pager module, or a cellular telephone module. The Commercial two-way communication module 350 provides a duplex communication path for the theft deterrent unit to communicate with vehicle owners and/or law enforcement authorities.

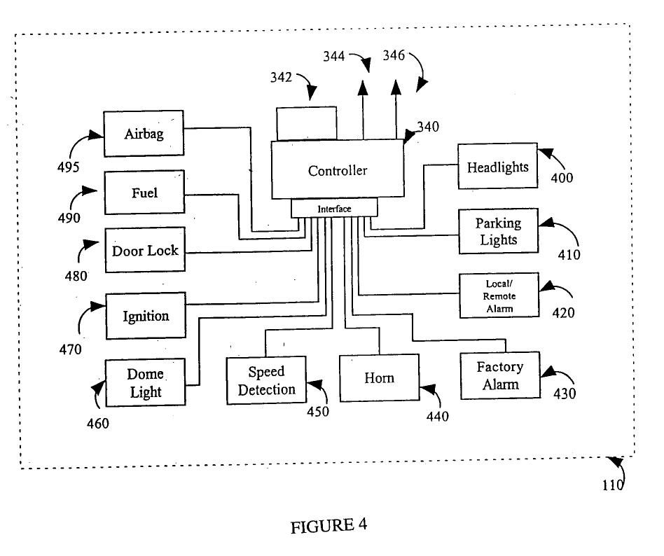

FIG. 4 illustrates a block diagram of the vehicle theft deterrent unit 300 illustrated in FIG. 3 interfaced with various systems of the vehicle 110 illustrated in FIG. 1.

The vehicle 110 includes a headlight system 400, a parking lights system 410, a local/remote alarm system 420, an optional factory alarm system 430, a horn system 440, a speed detection system 450, a dome light detection 460, an ignition system 470, a door lock system 480, a fuel system, and an airbag system 495. As discussed above, the various systems are interfaced with the vehicle theft deterrent unit 115 via the vehicle interface 330.

The controller 340 also includes an additional multipurpose interface 342 and two serial outputs 344, 346. Serial outputs 344, 346 may be used to output video data or to output remote display data from the controller 340.

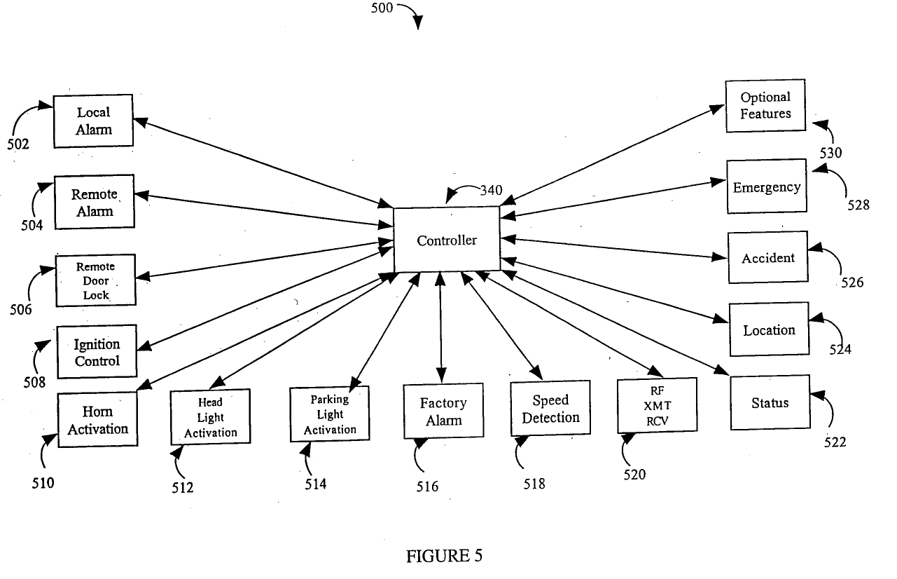

FIG. 5 illustrates a flow diagram 500 of the overall functionality implemented by the controller 340 of the vehicle theft deterrent unit 115 illustrated in FIG. 1.

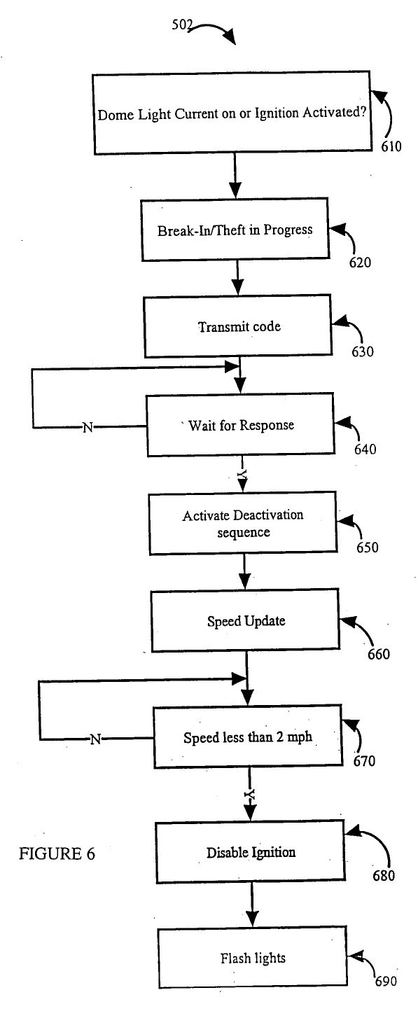

As shown in FIG. 5, the controller 340 implements in software a local alarm module 502, a remote alarm module 504, a remote door lock module 506, an ignition control module 508, a horn activation module 510, a head light/parking light activation module 512, 514, a factory alarm module 516, a speed detection module 518, a radio frequency (RF) transmit and receive module 520, a status module, 522 and a location module 524. The local alarm module 502 implemented by the controller 340 is illustrated in a more detailed flow diagram in FIG. 6.

In step 610, the controller 340 detects a dome light current from the dome light system 460 or ignition from the ignition system 470 of the vehicle 110.

The controller 340 interprets these events as a theft/break-in, in step 620.

The controller 340 in response to step 620 transmits a code to the security service provider 130, in step 630 and begins waiting for a response code from the security service provider in step 640.

Upon receiving the response code from the security service provider 130, the controller 340 activates the deactivation sequence for the vehicle 110 in step 650. The deactivation sequence may include disabling the vehicle 110 when the speed of the vehicle 110 drops below a predetermined speed, e.g., five (5) miles per hour with an error margin of plus or minus 2 mph, flashing lights and the horn.

In step 660, the controller 340 periodically polls the accelerometer module 320 for the speed of the vehicle 110. Subsequently, the speed information is transmitted back to the security service provider 130. Once the deactivation sequence has begun, the controller 340 monitors the speed of the vehicle in step 670. If the speed of the vehicle 110 drops below 2 mph, the controller 340 signals the ignition system 470 to turn the ignition off.

In step 690, the controller 340 signals the headlights system 400 and the parking light system 410 to begin flashing. The controller 340 also signals the horn system 440 to begin beeping. With the lights flashing and the horn beeping, bystanders will know that the vehicle 110 is in some sort of distress.

Returning to FIG. 5, the remote alarm module 504 implemented by the controller 340 provides for the vehicle owner and/or law enforcement may remotely deactivate the vehicle ignition and activate the alarm functions. However, the ignition will not be disabled unless the speed is detected at less than 2 mph. Additionally, the remote alarm function may include door unlock, alarm off, a horn sound, and a light flash for vehicle location. The remote alarm function may also include a long term ignition disable.

The remote door lock modulel 506 implemented by the controller 340 provides for two options of opening the doors of the vehicles. The owner of the vehicle may have a keyless remote control which is a radio frequency device that allows the owner to unlock/lock the vehicle and deactivate/activate the alarm functions. The owner of the vehicle also has the option to open the doors through the security service provider 130.

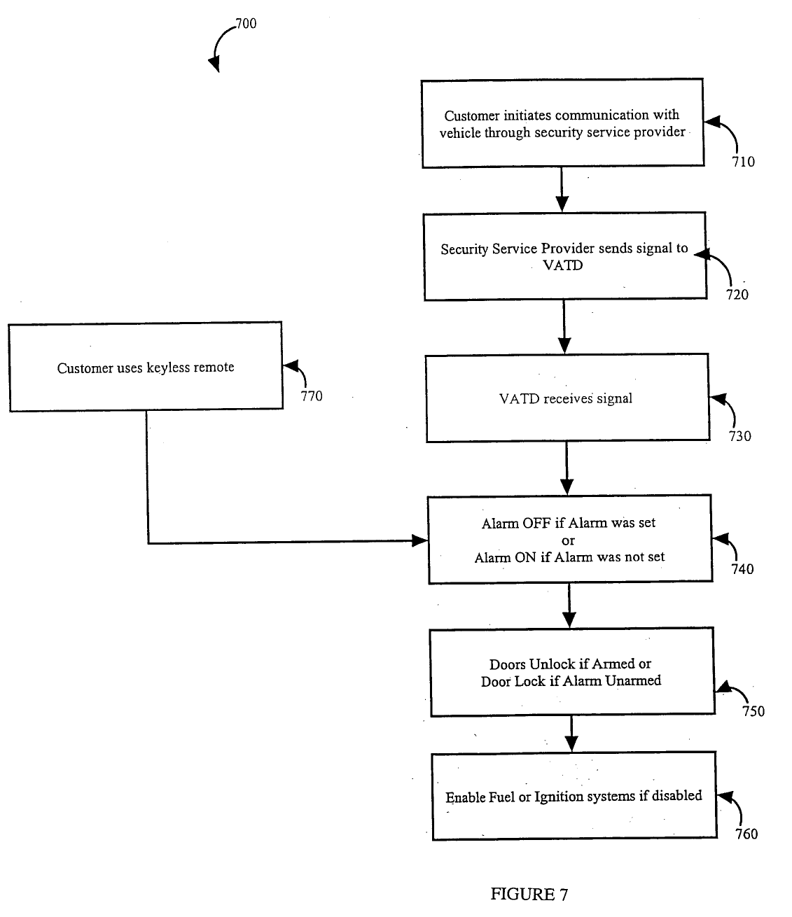

FIG. 7 illustrates a more detailed flow diagram 700 of the remote door lock module 506 implemented by the controller 340.

In the event that the owner does not have the keyless remote control and wants entry into the vehicle, the owner may open the door and disable the alarm if set by contacting the security service provider 130 in step 710. The owner may contact the security service provider 130 using a telephone, a pager or the Internet illustrated in FIG. 2.

In step 720, the security service provider 130 signals the vehicle theft deterrent unit 115 over the commercial two-way system 120.

Upon receiving the signal, the controller 340 deactivates the alarm if the alarm was set or activates the alarm if the alarm was not set, in step 740, and unlocks the doors by signaling the door lock system 480 to open or locks the door if the alarm was not armed in the previous step, in step 750.

The controller 340 also enabled the fuel system 490 or the ignition system 470 if the systems were disabled.

Returning to FIG. 5, the ignition control module 508 implemented by the controller 340 provides for the controller 340 to enable or disable the ignition system 470 of the vehicle 110. The ignition system 470 is disabled through the use of a transistor that is biased normally closed. The controller 340 and a latching relay control the function of the transistor.

The ignition control module 508 also provides for disabling the ignition system 470 by contacting the security service provider 130 and requesting the security service provider 130 to disable the ignition system 470 as well as locally by a keyless remote control.

The horn activation module 510 provides for the controller 340 the capability to activate the horn. The horn is activated to indicate that the alarm is activated by the keyless remote control 1701 or by the security service provider 130. In this case, the horn sounds for approximately 0.25 seconds.

The horn activation module 510 also provides for sounding the horn for up to five minutes in the event that the local alarm system 502 has been activated and the ignition system 420 has been disabled.

The horn activation module 510 may also provide for a vehicle location function. In the even that an owner of the vehicle 110 were to forget where the vehicle was parked. The owner of the vehicle would then call the security service provider 130 to initiate a car finder function. The security service provider 130 would send a signal to the vehicle theft deterrent unit 115 to activate the horn. The controller 340 would receive the signal and activate the horn system 440 for five minutes to allow the owner of the vehicle to locate the vehicle.

The head light activation module 512 provides for the controller 340 the capability to activate the headlights of the headlight system 400. The headlights are activated to indicate that the alarm is activated by a keyless remote control. In this case, the headlight lights for approximately 0.25 seconds.

The head light activation module 512 provides for activating the headlights for up to five minutes in the event that the local alarm system 502 has been activated and the ignition system 420 has been disabled.

The head light activation module 512 may also provide for a vehicle location function. In the event that an owner of the vehicle 110 were to forget where the vehicle was parked. The owner of the vehicle would then call the security service provider 130 to initiate a car finder function. The security service provider 130 would send a signal to the, vehicle theft deterrent unit 115 to activate the headlights. The controller 340 would receive the signal and activate the headlight system 400 for five minutes to allow the owner of the vehicle to locate the vehicle.

The parking light activation module 514 provides for the controller 340 the capability to activate the lights of the parking light system 410. The parking lights are activated to indicate that the alarm is activated by a keyless remote control. In this case, the parking lights for flashed approximately 0.25 seconds.

The parking light activation module 514 provides for activating the parking lights for up to five minutes in the event that the local alarm system 502 has been activated and the ignition system 420 has been disabled.

The parking light activation module 514 may also provide for a vehicle location function. In the even that an owner of the vehicle 110 were to forget where the vehicle was parked. The owner of the vehicle would then call the security service provider 130 to initiate a car finder function. The security service provider 130 would send a signal to the vehicle theft deterrent unit 115 to activate the headlights. The controller 3401 would receive the signal and activate the parking light system 410 for five minutes to allow the owner of the vehicle to locate the vehicle.

The factory alarm module 516 provides for the controller 340 the capability to detect an installed factory alarm system. In this event, a keyless remote control of the factory alarm system could control the vehicle theft deterrent unit 115. In this manner, the vehicle theft deterrent system 100 lowers the cost to the owner since the owner does not have to replace his current alarm system.

The speed detection module 518 provides for the controller 340 the capability to detect the speed of the vehicle. The speed detection module 518 monitors data signals from the accelerometer module 320. The speed detection is used by the vehicle theft unit for two basic system functions: one, transmitting through the two-way communication module 350 the speed of the vehicle and to ensure that the ignition system 470 is not deactivated while the vehicle is moving at a high rate of speed. However, law enforcement authorities may deactivate the ignition system 470 at any time or any speed so long as it is deemed safe.

The RF transmit and receive module 520 provides the necessary control signals for the controller 340 to control the two-way communication module 350 for the vehicle theft deterrent unit 115 to communicate with the security service provider 115.

The status module 520 provides the controller 340 the status of the vehicle theft deterrent unit 115. The status I module 520 polls a set of latching relays on a parallel port of the controller 340. The latches store the last status and transistors to control any external functions.

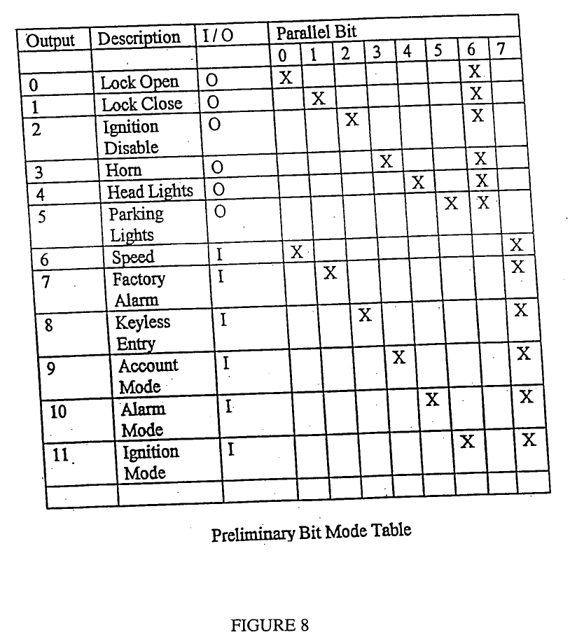

The status bits are shown illustrated in FIG. 8.

The location module 522 provides the controller 340 the position and location data from the location positioning module 310. The controller 340 signals the GPS module 310 for data, and the location positioning module 310 returns position and location information which includes latitude and longitude information.

The accident module 526 provides the controller 340 information of whether the vehicle has been involved in an accident. The accident module 526 monitors whether the airbags have been deployed from the airbag sensor system 495. If the airbags have been deployed, the controller 340 signals the two-way communication module 350 to generate an accident code which would 30 include location information to the security service provider 130. The security service provider 130 would then inform law enforcement authorities and/or medical personnel to provide aid to the owner of the vehicle.

The emergency module 528 provides the controller information of whether the owner or the customer of the security service needs emergency service. In the event of an emergency event, the owner would press the emergency button 174 on the keyless remote 170. The keyless remote sends a signal to the vehicle theft deterrent unit 115. Upon receiving the signal, the controller 340 signals the two-way communication module 350 to send an emergency code which includes location information from the location positioning module 310 to the security service provider 130. The security service provider 130 would then inform law enforcement authorities and/or medical personnel to provide aid to the owner.

The controller 340 may also implement some optional feature module 530. The optional features may include a remote start, a remote window control, or a remote shock sensor.

While the invention has been described with reference to the exemplary embodiments thereof, those skilled in the art will be able to make various modifications to the described embodiments of the invention without departing from the true spirit and scope of the invention.

1. A vehicle theft system adapted for cooperation with a security service provider over a network comprising:
a security service provider coupled to a network;
a police network coupled to said security service provider through said network;
a customer unit in communication with said security service provider; and
said security service provider being configured to notify said police network in the event of a theft of said customer unit.

2. The vehicle theft system of claim 1, wherein said network comprises the Internet.

3. The vehicle theft system of claim 2, wherein said security service provider is configured to provide information associated with said customer unit to said police network over said network.

4. The vehicle theft system of claim 3, wherein said information is provided to said police network via a web site.

5. The vehicle theft system of claim 4, wherein said customer unit comprises a vehicle theft deterrent unit installed in a customer vehicle, said vehicle theft deterrent unit being configured to remotely deactivate said customer vehicle.

6. The vehicle theft system of claim 5, wherein said deactivation is accomplished by said security service provider over said network.

7. The vehicle theft system of claim 6, further comprising an insurance provider coupled to said security service provider through said network, and said security service provider is configured to notify said insurance provider in the event of a theft of said customer vehicle.

8. A vehicle theft system adapted for cooperation with a security service provider over a network comprising:
security service provider means coupled to a network;
police network means coupled to said security service provider means through said network;
customer unit means in communication with said security service provider means; and
said security service provider means comprising means for being notifying said police network means in the event of a theft of said customer unit means.

9. The vehicle theft system of claim 8, wherein said network comprises the Internet.

10. The vehicle theft system of claim 9, wherein said security service provider means comprises means for providing information associated with said customer unit means to said police network means over said network.

11. The vehicle theft system of claim 10, wherein said information is provided to said police network via a web site.

12. The vehicle theft system of claim 11, wherein said customer unit means comprises vehicle theft deterrent means installed in a customer vehicle, said vehicle theft deterrent means comprising means for remotely deactivating said customer vehicle.

13. The vehicle theft system of claim 12, wherein said deactivation is accomplished by said security service provider means over said network.

14. The vehicle theft system of claim 13, further comprising insurance provider means coupled to said security service provider means through said network, and said security service provider means comprising means for notifying said insurance provider in the event of a theft of said customer vehicle.
